(19) United States
(12) Patent Application Publication
(10) Pub. No.: US 2007/0250516 A1
(43) Pub. Date: Oct. 25, 2007

(54) MEMBER CENTRIC INFORMATION DISSEMINATION SYSTEM

(75) Inventors: Kathleen A. DAHLBERG, Village of Palmetto Bay, FL (US); Terry L. CARPENTER, Fleetwood, PA (US); James A. ROTHENBERGER, Reading, PA (US); Terry L. CARPENTER, Douglasville, PA (US)

Correspondence Address: H.C. PARK & ASSOCIATES, PLC, 8500 LEESBURG PIKE, SUITE 7500, VIENNA, VA, 22182, US

(73) Assignee: ONEBIZTONE LLC, Laureldale, PA (US)

(21) Appl. No.: 11/740,094

(22) Filed: Apr. 25, 2007

Related U.S. Application Data
(60) Provisional application No. 60/745,594, filed on Apr. 25, 2006.

(51) Int. Cl. G06F 17/30

(52) U.S. Cl. 707/10

(57) ABSTRACT

A member centric information dissemination system in which individuals may easily join and participate in multiple, unrelated groups. Individuals may maintain all or some of their contact information private, and they have the ability to set rules for each group on how and when information may be disseminated to them.

### CROSS REFERENCE TO RELATED APPLICATION

This application claims the benefit of U.S. Provisional Patent Application No. 60/745,594, filed on Apr. 25, 2006, which is hereby incorporated by reference for all purposes as if fully set forth herein.

### BACKGROUND OF THE INVENTION

1. Field of the Invention

The present invention relates to information dissemination among group members.

2. Discussion of the Background

Generally, with the advent of mobile phones, personal data assistants (PDAs), pagers, email, voice mail, and facsimiles, getting in contact with others has never been easier. However, the advent of these devices creates new complexities. With home and business phone numbers, personal and business mobile phone numbers, pagers, and email addresses, there are numerous modes available for contacting someone. Yet, when multiple modes of communication are available, it may often be a challenge to select the correct number or address to contact another. This may cause a particular problem in cases where timeliness of the information dissemination is critical.

Groups of people, whether related for business, recreational, or other purposes, often need to communicate with other members of their particular group. Hence, numerous messaging systems have been designed to facilitate multi-modal communications within a group. Since there may be multiple ways to contact each group member, the group leader typically will gather all pertinent contact information to create some form of contact list. In this case, the group leader and/or organization the group leader represents generally acts as the de facto custodian of the group members' contact information.

While such messaging systems may permit a broadcast message to be sent to multiple group members via unique communication modes, such as telephone and email, they are not without drawbacks. For example, the requirement to provide personal contact information, such as home phone numbers, personal mobile phone numbers, and personal email addresses, diminishes each member's privacy. Also, the contact information for team members frequently changes. Furthermore, people often belong to multiple groups, such as a job-related group and a recreational group (e.g., youth sports league), and they must provide personal contact information to each group leader or organization to which they belong. Additionally, prior art multiple-mode communications systems are typically expensive to implement, and it may also be expensive to increase the system's capacity. The effort to implement these disparate options is the responsibility of the group leader: gather the information, input the contacts into the various systems and manage the system's activities.

With the expanding technology of the Internet and wireless communication, virtual work forces and teams are expanding in use and demands for functionality. Individuals who own various communication devices may be part of numerous, unrelated groups that require fast, reliable, and secure information dissemination amongst group members. Yet, prior art systems are generally built to support the organization's needs, rather than the needs of the individual (i.e. the group member).

Hence, a member centric information dissemination system, designed with the needs of group members in mind, is needed. Such a system should integrate natively with older communications technology. It should be easy to operate from a management/leader perspective, as well as group member perspective, and it should be easily scalable and cost efficient. Furthermore, the system should protect the privacy of the group members and their contact information based on the privileges the group member assigns to this information for public, group, and coordinator access.

### SUMMARY OF THE INVENTION

This invention provides a member centric information dissemination system in which individuals may easily join and participate in multiple, unrelated groups. Group members may establish privacy settings to restrict access to some or all of their contact information, and they may have the ability to set rules for each group on how and when they prefer be contacted.

The invention also provides an information dissemination system for organizations and group coordinators that need to disseminate information to group members quickly, reliably, and easily over multiple communication modes.

Additional features of the invention will be set forth in the description which follows, and in part will be apparent from the description, or may be learned by practice of the invention.

The present invention discloses a system for disseminating information amongst a group including a group coordinator and group members. The system includes a data store to store information relating to the group. The stored information includes group member profiles that include contact points and privacy settings of the group members. A trusted agent includes a message manager and a member agent, and the trusted agent is in communication with the data store. The message manager enables the group coordinator to disseminate a message to the group members via the contact points of the group members, and the member agent enables a first group member to set a first privacy setting to prevent a second group member or the group coordinator from seeing the contact points of the first group member.

The present invention also discloses a method for disseminating information among a group including a group coordinator and group members. The method includes establishing group member profiles for the group members. The group member profiles include contact points and privacy settings of the group members. A message is generated for dissemination, and then disseminated via the contact points of the group members. A first group member or the group coordinator is prevented from seeing the contact points of a second group member according to the privacy settings of the second group member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an information dissemination system according to an exemplary embodiment of the present invention.

FIG. 2 shows an information dissemination system according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art.

It will be understood that the system and methods of the invention may be used for information dissemination by any group. In other words, the invention is not limited to commercial, government, private sector, education, or personal use, and it may be used by groups of any size.

The term “message” as used herein is not limited by length or type of communication. It may refer to any type of information that may be transmitted using the applicable communication medium.

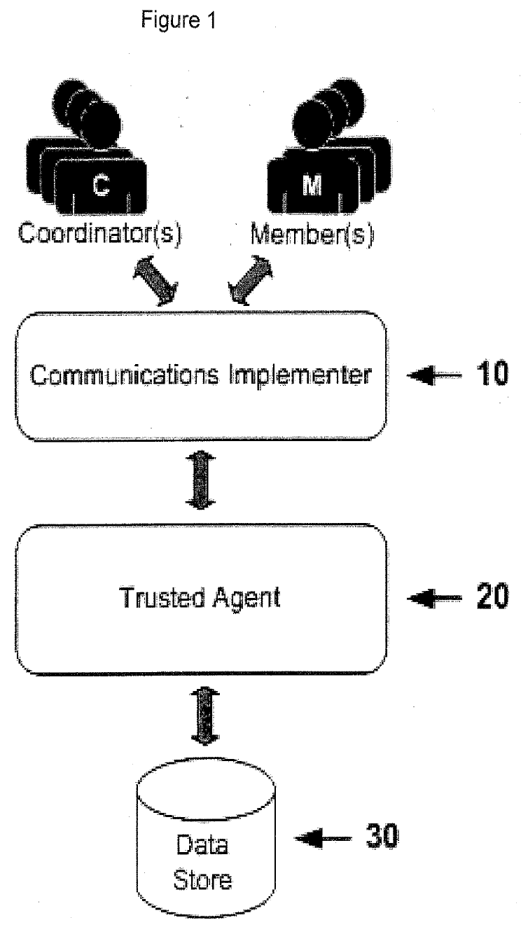

FIG. 1 shows an information dissemination system according to an exemplary embodiment of the present invention. Referring to FIG. 1, the information dissemination system includes a trusted agent 20 and a data store 30, which enable information dissemination among a group coordinator and group members using a communications implementer 10.

The group coordinator performs group coordination functions such as establishing, setting up, inviting or adding members, creating and sending messages, and establishing appropriate settings, functionalities, and permissions for the group. After joining or being added to the group, the group members establish or confirm their personal profiles, which include contact information and settings regarding the sending and receiving of information. Group members also maintain their profile according to individual preference, and they receive information disseminated from the trusted agent 20. The communications implementer 10 enables communications between the group coordinator/members and the trusted agent 20, which enables member centric information dissemination. The trusted agent 20 may be implemented using software modules that may be stored on a computer-readable medium and executed by a computer. For example, an Intel-based server with a Linux Operating System may be used. However, as one of ordinary skill in the art would recognize, there are numerous operating systems (such as Windows, MacOS, etc.) and hardware architectures (such as PowerPC, Sun Sparc, etc.) that could be used.

The data store 30 is used to store information related to group operation such as group coordinator/member profiles, security settings, messages, message status, and any other data used for system operation. Data store 30 could be implemented using a wide variety of database systems. For example, the data store may be implemented using a Relational Database Management System (RDBMS) and a single database or multiple databases may be used.

Here, the group coordinator/members may interact with the trusted agent 20 via the communications implementer 10. For example, the group coordinator interacts with the trusted agent 20 via the communications implementer 10 to create a message for dissemination to group members. The trusted agent 20 then sends the message to the group members via the communications implementer 10 as per individual member rules and settings, which may be stored in the data store 30. The trusted agent 20 includes logic that, in accordance with data stored in the data store 30, arranges and manages delivery of a message to each member in accordance with the mode and parameters set by the member.

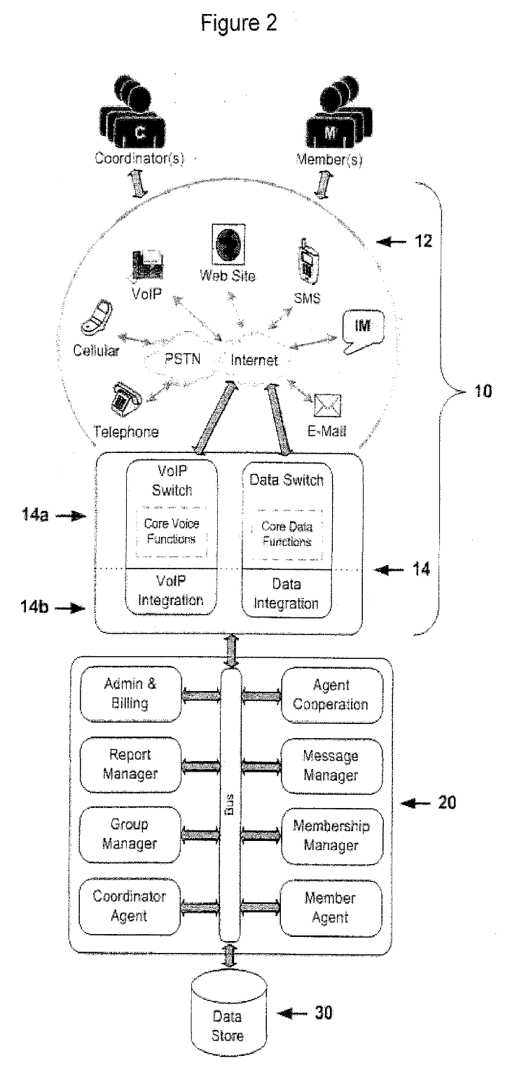

FIG. 2 shows an information dissemination system according to an exemplary embodiment of the present invention. Referring to FIG. 2, the communications implementer 10 may include multiple communication modes 12 and a communications manager 14. For example, communication modes 12 may include a telephone, cellular telephone, Voice over Internet Protocol (VoIP), Peer-to-Peer (P2P) VoIP, VoIP over Instant Message (IM), the host Web site (i.e. the Web site for the information dissemination system), short message system (SMS), Instant Message (IM), and email. Here, the telephone and the cellular telephone may communicate with the trusted agent 20 via the public switched telephone network (PSTN), the Internet, and the communications manager 14, while the other communication modes may communicate with the trusted agent 20 via the Internet and the communications manager 14. The communications manager 14 may utilize off-the-shelf commercial or open-source technology to implement the actual communications with any of the various communications modes 12.

Hence, when using an information dissemination system according to an exemplary embodiment of the present invention, the group coordinator/members may interact with the trusted agent 20 via multiple modes of communication. Consequently, the group coordinator/members may participate in an information dissemination system according to an embodiment of the invention without having to purchase expensive equipment or specialized communications services to implement the system. In most cases, the group coordinator/members may communicate with the trusted agent 20 using their existing communication devices and/or services.

The communications manager 14 includes a communications switch 14a, which enables the various communication modes 12 and the communications manager 14 to communicate with each other, and a communications integrator 14b, which allows the communications manager 14 and the trusted agent 20 to communicate with each other. The communications switch 14a includes a VoIP switch and a data switch. The VoIP switch is used for voice communications, and it generates outbound calls initiated by the trusted agent 20 and answers or routes inbound calls from the Internet. The data switch sends and receives data to and from the Internet based on request from various communications clients such as a communication mode 12 used by a group coordinator/member or the trusted agent 20. The protocols used in the data switch to route data to and from the Internet are based on standards for each type of data service, such as Web (http), e-mail (SMTP), Instant Messages (ICQ, AIM, MSN, YAHOO, GoogleTalk, Jabber/XMPP, Jingle, etc.).

The communications manager 14 also includes the communications integrator 14b, which allows the communications manager 14 (i.e. the communications switch 14a) and the trusted agent 20 to communicate with each other. The communications integrator 14b includes a VoIP integration module and a data integration module, which communicate with the VoIP switch and the data switch, respectively. The VoIP integration module is a software component that is used to simplify communications and integration to and from the VoIP switch. This integration is used to allow the trusted agent 20 to direct the VoIP switch to process various voice communication tasks such as sending messages, recording messages, processing input from a coordinator or member using an interactive voice response system (IVR), and play back of messages via a phone, as well as to allow the VoIP switch to pass information to the trusted agent 20. The data integration module is a software component that is used to gather, manage, and coordinate data communications between the trusted agent 20 and the data switch.

The trusted agent 20 may include the following modules: administration and billing, report manager, group manager, coordinator agent, agent cooperation, message manager, membership manager, and member agent. These modules may be software components designed to implement various functionalities that are described below. The trusted agent 20 modules may communicate with each other, the communications integrator 14b of the communications manager 14, and/or the data store 30 via a bus. All modules allow for the coordinator to have a “self-service” ability to extract data from the modules to other formats, such as Microsoft Excel, Adobe PDF, text file, etc., to facilitate the coordinator's management of the group and performance of their external responsibilities.

The report manager facilitates various canned and custom reports. This component also enables the group coordinator through simple or wizard-like tools to generate additional custom reports. For example, the group coordinator may generate reports to show when the last time group members updated their information, message disposition during transmission or after completion, and/or group membership. The report manager may also permit group members to generate reports regarding messages received, group member list (based on individual member privacy settings), and/or group memberships to which this member belongs. The report manger promotes a self-service ability for coordinators and members to manage and have line-of-sight to their responsibility and accountability for communications within a group, along with the group's readiness to operate with the necessary communications.

The group manager facilitates the creation of new groups along with all the policy decisions on how the group will be operated. This component also manages the association between coordinators and groups. For example, using the group manager, the group coordinator may create additional groups independent of or in a hierarchy with the original group. The group coordinator could also designate coordinators of subgroups and temporarily or permanently promote members to be alternate coordinators.

The coordinator agent manages the preferences of a coordinator such as when to notify the group coordinator of the status of messages in transit, such as every thirty minutes, after 50% of the members respond, or after completion. It may also work with the other components to retrieve information on behalf of the coordinator. This could be as simple as reporting the status of message distribution on a regular time interval set by the coordinator for a particular group. The coordinator agent may then engage the message manager to ensure the requested information is received by the coordinator according to their profile.

The message manager coordinates the distribution of information to the communications manager 14 along with recording of status information received from the communications manager 14. Such status information may include messages sent or acknowledged and the timing of each message event, the communications mechanism that was used to receive the message, and polling or answers received from members based on the message's request. This component also has the ability to alarm other components for issues in message distribution, such as if a member's contact information is not valid. Notifications may be created and delivered to the coordinator through their preferences and/or notifications of the non-working contact point can be sent to a member at any of their operating contact points. In this case, the message manager would inform the agent cooperation module, which in turn would facilitate with any of the other modules necessary to gain resolution to invalid contact information. For example, if a member's email address is no longer valid, an email from the message manager will not be delivered to it. In this case, the trusted agent 20 is capable of determining that the email address is no longer valid, and it may call or email the member at one of the member's alternate contact points to notify the member of the discrepancy. Similarly, if an email from the message manager is blocked by, for example, a firewall or spam filter, the trusted agent 20 is capable of determining that the email was blocked, and it may call or email the member at one of the member's alternate contact points to notify the member of the problem. Hence, rather than just disseminate information to group members without regard for whether each contact point is valid, the trusted agent 20 may determine whether a contact point is valid and then contact a member having an invalid contact point via an alternative contact point.

The membership manager coordinates the multi-dimensional relationship between members and groups. This component engages the message manager to invite new or existing members to join groups at the request of the group manager. It also ensures that members with multiple modes of communication and contact points have the ability to associate a group invitation to their one account rather than being forced to open a new account.

The member agent manages the preferences of a member such as how and when they would like to be contacted and/or personal privacy by not displaying contact information to the group coordinator and/or group membership. It works with the other components to retrieve information on behalf of the member. For example, the member agent may maintain the privacy of the member even in groups designated as public groups. Additionally, the member agent could engage in negotiations with the group coordinator agent through the agent coordinator, based on its knowledge of the member's preferences, to identify new groups that may be of interest to the member, manage member requests to join new groups with the coordinator agent, and etc.

The administration and billing component manages billing collation and distribution for both the group coordinator and system. It also manages routine maintenance and support functions for the overall system. It may provide usage reporting, membership and messaging history as appropriate. This administration may also provide for the transition of coordinators and payment methods, if applicable.

The agent cooperation component facilitates negotiations between the coordinator agent and the member agent, which act on behalf of a coordinator and member, respectively. This facility could be as simple as ensuring member privacy is maintained in a public group or recommending new groups of interest to a member which have an open membership and are looking for new members.

### Group Creation

An example of how a group coordinator may establish a group in an information dissemination system according to exemplary embodiments of the invention is described below.

The group coordinator may interact with the group manager to create the group's profile and operating parameters via the various communication modes 12 of FIG. 2, such as the host Web site, telephone, VoIP, and cellular telephone. The group's profile may include information such as group name, group size, expected usage amount, and, if applicable any fees. Operating parameters may include whether the group may include sub-groups, whether one or more alternate coordinators may be designated, authorized modes of communications for the group, enablement of text-to-speech and/or speech-to-text, membership confirmation and/or restrictions, and policy and security settings. In the event the group coordinator designates one or more alternate coordinators, the group coordinator may permit the alternate coordinator(s) to perform all or some of the functions available for coordinators. Examples of the policy and security settings include whether the group will be a public or private group, the standard time of operations, whether the group will be active year-round or seasonal, available message assurance levels, and member privileges. Message assurance levels may include the trusted agent 20 requiring authentication from the person receiving the message before delivery. Member privileges may include the ability to create and/or schedule messages, delete or change messages, and/or build custom reports. After creating the group's profile and operating parameters, the group coordinator may then use the membership manager and message manager to send invitations to join the group to potential group members, insert members into the group for confirmation by members, or bulk import of members for confirmation by each member. In this case, the message manager typically sends an email invitation to potential group members and then notifies the group coordinator when a potential group member receives the invitation, as well as the potential member's response. Hence, in order to establish an information dissemination system according to an embodiment of the invention for a group of any size and composition, a group coordinator need only have Internet access with a standards-compliant Web browser, such as Microsoft Internet Explorer, Mozilla Firefox, Opera, Netscape, Safari, and Konqueror.

Individuals receiving an invitation or confirmation of pending membership from the trusted agent 20 may join the group or confirm inclusion in the group. For example, the message manager may send an email invitation, including a link to the group's area, to each group invitee. The invitee may then use the link to access the group area, where the invitee will be able to interact with the membership manager and member agent in order to become a group member. For example, the member may create his or her profile, establish privacy settings, and complete training and certification.

In creating the member profile, the member enters pertinent contact points such as mailing address, email address(es), IM addresses, home, mobile, and work telephone numbers, pager numbers, etc. The member may also designate which of these contact points is his or her primary contact point for that group. The primary contact point is the point to which the trusted agent 20 will first look to disseminate information. If desired, a member may also designate more than one contact point for receiving information. In this case, the message manager will disseminate the information to each designated contact point starting with the primary contact point. In other words, the member may almost simultaneously receive the same information over multiple modes of communication. The member may also designate other contact points for the message manager, in priority order, should the message manager fail to contact the member at the primary contact point. Additionally, the member may designate the capability of a contact point so that the message manager may determine, before transmission, whether a certain piece of information may be transmitted to that contact point. For example, if a member owns a wireless PDA, the member may indicate whether the contact point associated with that device is capable of receiving certain attachments, such as a voice recording or text file. Accordingly, the member provides various contact points for the trusted agent 20, which has the capability to disseminate information to each contact point in accordance with the settings provided by the member. Since the trusted agent 20 may communicate with various types of devices via the communications manager 14, group members may actively participate in a group without purchasing any special equipment or loading any software on their devices.

In addition to providing contact information, the member may also designate conditions of the member's participation in a group. For example, the member may instruct the member agent to keep some or all of their contact points private. Hence, the member may allow the group coordinator to see all of the member's contact points, or the member may prohibit the group coordinator from seeing any of the member's contact points. The group coordinator does not need access to the member's contact points because the trusted agent 20 will disseminate information from the coordinator to the member per the contact points set by the member. Furthermore, the member may place restrictions upon when the message manager may deliver information to the member. For example, the member may instruct the message manager to deliver information only between the hours of 8 a.m. and 8 p.m. The message manager will abide by such instructions unless overridden by the group coordinator, who has the capability to disseminate appropriately designated information at any time using the coordinator agent. In this case, the group coordinator may designate dissemination of a certain piece of information as an “emergency,” which would override any member-created dissemination restrictions. Additionally, the member may designate privacy settings that allow the member agent to override the member's privacy of contact information on a group-by-group basis.

With an information dissemination system according to an embodiment of the invention, the membership manager permits an individual to join and participate in multiple, distinct groups under a single profile. The membership manager enables the member's participation in multiple, distinct groups, and the member agent permits the member to establish different settings for each group. For example, a member may choose to let the group coordinator and/or group members of one group see all of this member's contact points, but may choose to prevent the group coordinator and/or group members of another group from seeing any contact points. Furthermore, the member may choose a different primary contact point for each group, as well as different priority orders of alternate contact points. The message manager is able to disseminate information to the member, for each group to which the member belongs, according to the member's instructions, which may be different for each group. Consequently, a member can participate in multiple, distinct groups with a single set of contact points provided to the trusted agent 20, and the trusted agent 20 will disseminate information and maintain settings according to the member's instructions for each group to which the member belongs.

The trusted agent 20 communicates with the data store 30 so that it may manage membership and disseminate information according to the settings received from the group coordinator and group members.

### Information Dissemination

An example of how the information dissemination system may be used to disseminate information to group members is described below according to exemplary embodiments of the invention.

Once the group is established, the group coordinator may easily disseminate information to the group using the information dissemination system. For example, the group coordinator may sign in to the coordinator Web site to establish a session to create a message. Here, the group coordinator interacts with the message manager to create the message and establishes any confirmation and/or answer requirements. Alternatively, the group coordinator may interact with the message manager via another communication mode, such as a cellular telephone, to create and send a message to the group. However, in any case where the coordinator desires to disseminate a message to group members, the coordinator need only create the message and instruct the message manager to disseminate it. The group coordinator may instruct the message manager to send information to one, some, or all group members. Furthermore, if authorized by the group coordinator, the message manager may permit one or more group members to create and disseminate information to other group members and/or the group coordinator.

After receiving information to be disseminated along with any applicable parameters, the message manager then disseminates the information to group members' contact points. Hence, the group coordinator no longer needs to place call after call, track who has and has not been reached, and gather responses that may have been provided by members. Rather, the message manager contacts members using the members' designated contact point(s) and tracks message receipt as well as responses thereto. After receiving the information, a group member may complete any appropriate response, if requested, such as by indicating the response using a telephone keypad or by responding orally. If the message manager does not receive confirmation of receipt from any group member within a predetermined period of time, the message manager may then re-disseminate the information to the member's alternate contact points in the order designated by the member.

The message manager is also capable of determining an appropriate contact point for a member depending upon the type of information being disseminated. For example, if the group coordinator sends an email with an attachment, and group member A's primary contact point is a telephone number, the trusted agent 20 will determine if that contact point is capable of receiving the email and attachment. If not, the trusted agent 20 will determine group member A's highest priority contact point that is capable of receiving the email and attachment and disseminate the information to that contact point. In this case, the trusted agent 20 may also separately notify the group member A via group member A's primary contact point of the transmission to the alternate contact point.

After disseminating the information, the message manager then monitors actual receipt of the information, and where appropriate, it collects and monitors responses for real time display and/or notification to the group coordinator. For example, the trusted agent 20 may through multiple components, provide immediate notification in the method preferred or preset by the coordinator regarding the status of a message. The methods available to the coordinator are numerous, such as frequency or milestones for notification such as when 50% of the membership has received the message or every 30 minutes regardless of who has received the message. The group coordinator may instruct the trusted agent 20 to notify him or her, as per a communication mode of his or her choice, when one, some, or all group members receive and/or respond to a communication. In other words, the trusted agent 20 can provide tailored receipt and/or response reporting to the group coordinator.

The information dissemination system may receive and transmit various types of information including voice and text messages, as well as files including image data, text, moving images, etc. Furthermore, the system may transform inbound and outbound voice messages into text messages and vice versa, and allow customized responses to messages to gather information from the message recipient.

### Group Maintenance

In addition to creating groups and disseminating information, the group coordinator may easily interact with the trusted agent 20 to modify the group profile and operating parameters. This may be done via various communication modes, such as those shown in FIG. 2, utilizing the group manager module of the trusted agent 20.

Group members may also easily access and modify their profiles via various communication modes, such as those shown in FIG. 2, using the membership manager module of the trusted agent 20. For example, a group member who is temporarily at a location that is not reachable via the member's primary contact point may interact with the membership manager to set up a new, temporary primary contact point. Here, the group member may interact with the message manager via the host Web site, or may call the message manager using a telephone to modify the member's primary contact point and/or desired settings.

Advantages of a member centric information dissemination system according to embodiments of the invention include members do not have to provide any contact information to the group coordinator in order to receive messages because the trusted agent may be instructed to maintain the contact information in strict confidence. In other words, only the member has access to the member's contact information. Alternatively, the member may permit access to part of the member's contact information. Additionally, once a group member creates his personal profile with the trusted agent, the member may use that same profile for other, wholly unrelated groups. In other words, the trusted agent enables the member to join multiple, distinct groups, and it also allows the member to tailor rules, security, and privacy settings for each individual group that the member belongs to, while requiring the member to create only one profile. In other words, the member provides the trusted agent with the member's contact information once. Furthermore, the member can receive information from the group coordinator in a manner that the member chooses. For example, the member may designate a primary contact point, such as a cellular phone number, and the trusted agent will initially disseminate voice, text, or other appropriate messages to that cellular phone number. The member may also designate alternative contact points, such as home phone, personal email, etc., in priority order that the trusted agent will follow until receiving confirmation of the member's receipt.

Furthermore, the group coordinator/members may participate in an information dissemination system according to an embodiment of the invention without having to purchase expensive equipment to implement the system because the group coordinator/members may be able to access the trusted agent with existing communication devices and/or services. This architecture may provide better functionality over existing message broadcast systems at a fraction of the cost by utilizing the trusted agent to tie various technologies together into a seamless information dissemination system. Additionally, group coordinators have great flexibility in increasing the size of their groups with this architecture since they do not need to purchase additional equipment to increase the information dissemination system's capacity.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for disseminating information amongst a group comprising a group coordinator and group members, the system comprising:
a data store to store information relating to the group, the stored information comprising group member profiles comprising contact points and privacy settings of the group members; and
a trusted agent comprising a message manager and a member agent, the trusted agent being in communication with the data store,
wherein the message manager enables the group coordinator to disseminate a message to the group members via the contact points of the group members, and the member agent enables a first group member to set a first privacy setting to prevent a second group member or the group coordinator from seeing the contact points of the first group member.

2. The system of claim 1, wherein the member agent further enables the group members to choose the contact points to which the message will be sent.

3. The system of claim 1, wherein the member agent further enables the first group member to set a second privacy setting to permit the group coordinator to see the contact points of the first group member and to prevent other group members from seeing the contact points of the first group member, and a third privacy setting to prevent the group coordinator and the other group members from seeing the contact points of the first group member.

4. The system of claim 1, wherein the trusted agent further comprises a membership manager, the membership manager enabling the first group member to establish a primary group member profile, the primary group member profile serving as the first group member's profile for at least two different and independent groups.

5. The system of claim 4, wherein the member agent further enables the first group member to select at least two different contact points for each of the at least two different and independent groups and to set different privacy settings for each of the at least two different and independent groups.

6. The system of claim 4, wherein the membership manager further enables the group coordinator to invite a potential group member to join the group and enables the potential group member to join the group by accepting the invitation.

7. The system of claim 4, wherein the membership manager further enables the group coordinator to add a potential group member to the group and enables the potential group member to confirm the addition to the group.

8. The system of claim 4, further comprising:
a voice over internet protocol integration module to enable transmission of a voice message between the trusted agent and the group members; and
a data integration module to enable transmission of a data message between the trusted agent and the group members.

9. The system of claim 8, further comprising:
a voice over internet protocol switch connected to the internet; and
a data switch connected to the internet,
wherein the voice over internet protocol integration module enables transmission of the voice message between the trusted agent and the group members using the voice over internet protocol switch and the internet, and the data integration module enables transmission of the data message between the trusted agent and the group members using the data switch and the internet.

10. The system of claim 9, wherein the trusted agent, the voice over internet protocol integration module, and the data integration module each comprise a computer program encoded in a computer-readable medium.

11. A method for disseminating information among a group comprising a group coordinator and group members, the method comprising:
establishing group member profiles for the group members, the group member profiles comprising contact points and privacy settings of the group members;
generating a message for dissemination;
disseminating the message via the contact points of the group members; and
preventing a first group member or the group coordinator from seeing the contact points of a second group member according to the privacy settings of the second group member.

12. The method of claim 11, further comprising permitting the group member to choose the contact points to which disseminated information will be sent.

13. The method of claim 11, wherein the privacy settings of the group member permit the group coordinator to see the contact points of the group member and prevent other group members from seeing the contact points of the group member, or the privacy settings of the group member prevent the group coordinator and the other group members from seeing the contact points of the group member.

14. The method of claim 11, wherein the group member profile of the group member serves as the group member's profile for at least two different and independent groups.

15. The method of claim 14, wherein the group member selects at least two different contact points for each of the at least two different and independent groups and sets different privacy settings for each of the at least two different and independent groups.

16. The method of claim 14, further comprising:
sending an invitation from the group coordinator to a potential group member to join the group, the potential group member joining the group by accepting the invitation and establishing a group member profile.

17. The method of claim 14, further comprising:
adding a potential group member to the group by the group coordinator establishing the potential group member's profile, wherein the potential group member confirms the addition to the group.
